(19) United States
(12) Patent Application Publication
(10) Pub. No.: US 2010/0255295 A1
(43) Pub. Date: Oct. 7, 2010

(54) RESIN COMPOSITION, MOLDED ARTICLE THEREOF, AND KEY FOR TERMINAL EQUIPMENT

(76) Inventors: Tomomitsu Onizawa, Tokyo (JP); Naoshi Takahashi, Tokyo (JP); Akihiro Mukai, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/734,973

(22) PCT Filed: Dec. 5, 2008
(86) PCT No.: PCT/JP2008/072586

§ 371 Date: Jun. 7, 2010

(30) Foreign Application Priority Data
Dec. 7, 2007 (JP) 2007-317019
Feb. 8, 2008 (JP) 2008-029055
Apr. 10, 2008 (JP) 2008-102348

(51) Int. Cl. B29C 45/00; C08K 5/103

(52) U.S. Cl. 428/339; 264/328.16; 524/317

(57) ABSTRACT

A resin composition comprising 100 parts by weight of an aromatic polycarbonate having an OH terminal group content of 0.1 to 30 eq/ton (component A) and 0.01 to 0.3 part by weight of a glycerin monoester (component B) and having a chlorine atom content of 100 ppm or less.

The resin composition provides a molded article having excellent heat stability and a good color.

### TECHNICAL FIELD

The present invention relates to a resin composition suitable for high-temperature processing and a molded article thereof. More specifically, it relates to a resin composition which has excellent heat stability even when its molding temperature is high and can provide a molded article having a good hue, especially a key for terminal equipment.

### BACKGROUND OF THE ART

An aromatic polycarbonate resin is widely used in the industrial field because it is excellent in transparency, impact property, fatigue property, strength, dimensional stability, electric properties and flame retardancy. However, molded articles are recently, becoming thinner and thinner to reduce their weights and costs, and high-temperature molding is required more and more. Further, the requirement for the strength of a thin portion of a product is becoming higher, especially the chemical resistance of an aromatic polycarbonate resin becomes an issue in many cases, and therefore attempts are being made to achieve satisfactory properties by increasing the molecular weight of the aromatic polycarbonate resin. However, when the molecular weight of the aromatic polycarbonate resin is increased, its viscosity at the time of melting grows, whereby the molding temperature must be raised to mold it into a predetermined molded article.

In patent document 1, attempts are made to improve chemical resistance and moldability by adding a specific phosphorus compound to an aromatic polycarbonate resin and an alicyclic polyester resin. However, as compared with an aromatic polycarbonate resin, a polymer alloy with another resin cannot be put to practical use due to a hue change by alloying.

When an aromatic polycarbonate resin is molded at a high temperature, yellowing occurs, thereby deteriorating its hue. As proposed by patent document 2, attempts are made to improve the discoloration of an aromatic polycarbonate. However, further improvement is necessary. Especially when it is molded at a high temperature, an aromatic polycarbonate resin composition which can achieve a good hue is desired.

Meanwhile, more and more importance is attached to the portability and design of terminal equipment such as a mobile phone, and studies on the thinning of a key (may be referred to as “key top”) for terminal equipment are under way like patent document 3. Although the key of terminal equipment is thin, it must have such high strength to withstand pressure which is applied thereto repeatedly at the time of input by key-pushing. Further, the key of the terminal equipment must have excellent transparency and a clear impression in order to send a signal to a person carrying the terminal equipment by light when the terminal equipment receives or transmits a signal and from the viewpoint of its design. An aromatic polycarbonate resin is suitably used as an industrial material which has both transparency and strength.

Further, patent document 4 proposes that a key for terminal equipment is manufactured by molding an aromatic polycarbonate resin at a high temperature.

Moreover, a dye is added to the aromatic polycarbonate resin to increase the number of its colors, thereby making it possible to improve its design and also to increase the visibility of a character printed on the key by the development of a beautiful color.

However, the aromatic polycarbonate resin has such problems that its viscosity is high and that its molding temperature must be set high when a thin molded article is formed. However, when a key for terminal equipment is molded at a high molding temperature, the aromatic polycarbonate resin changes its color and a key for terminal equipment having a satisfactory appearance cannot be provided. Especially when a dye is added to the above aromatic polycarbonate resin, the degree of discoloration becomes high, which is a big problem in product quality. Further, when the molding temperature is high, a molded article is apt to stick to a metal mold, thereby causing a release failure. Since the key for terminal equipment is very small, the ratio of portions except a molded article, such as useless portion of molded article, sprue and runner which is formed during molding becomes high and the above discoloration problem becomes more serious though a hot runner is required to reduce costs. Therefore, there are many cases where it is difficult to obtain a hot runner mold.

(patent document 1) JP-A 2007-106984
(patent document 2) JP-A 2006-111684
(patent document 3) JP-A 2007-048602
(patent document 4) JP-A 2006-92951

### DISCLOSURE OF THE INVENTION

It is an object of the present invention to provide a resin composition which comprises an aromatic polycarbonate resin and has excellent heat stability and a good hue.

It is another object of the present invention to provide a resin composition which is free from discoloration and a release failure, has transparency and strength and can be dyed various colors.

It is still another object of the present invention to provide a molded article which is excellent in heat stability, hue, transparency and strength and can be dyed various colors and a manufacturing method thereof.

Since injection pressure is required to injection mold a thin molded article such as a key for terminal equipment, the molding machine becomes large in size. Accordingly, the cylinder capacity of the molding machine becomes large and the residence time of the resin in the cylinder tends to become long. Particularly when a small molded article such as a key for terminal equipment is molded, the residence time increases and accordingly, the hue of the molded article tends to become worse. Therefore, to mold a key for terminal equipment as a thin and small molded article, a resin composition which has excellent heat stability and releasability and hardly changes its color is required.

The inventors of the present invention have conducted intensive studies to attain the above objects and have found that the heat stability, discoloration and release failure of a molded article which is molded at a high temperature are improved by the chlorine atom content, the OH terminal group content and the type and amount of a release agent. The present invention has been accomplished based on this finding.

That is, according to the present invention, the following are provided.

1. A resin composition comprising 100 parts by weight of an aromatic polycarbonate having an OH terminal group content of 0.1 to 30 eq/ton (component A) and 0.01 to 0.3 part by weight of a glycerin monoester (component B) and having a chlorine atom content of 100 ppm or less.
2. The resin composition according to the above paragraph 1 which has a chlorine atom content of 0.1 to 100 ppm.
3. The resin composition according to the above paragraph 1 which comprises an anthraquinone-based dye having no OH functional group in the skeleton (component C) in an amount of 1×10⁻⁶ to 0.001 part by weight based on 100 parts by weight of the aromatic polycarbonate (component A).
4. The resin composition according to the above paragraph 1 which comprises a phosphorus-based heat stabilizer (component D) in an amount of 0.001 to 0.2 part by weight based on 100 parts by weight of the aromatic polycarbonate (component A).
5. The resin composition according to the above paragraph 1 whose molded article having a thickness of 2 mm has hue values within the following ranges as JISK7105 transmission measurement values when it is molded at 370° C.:
L value=85.0 to 90.0
a value=−1.3 to −1.9
b value=1.5 to 4.5.
6. The resin composition according to the above paragraph 1 whose molded article has a vacuum adhesion to a metal mold of 300 to 800 N when it is molded at a molding temperature of 350° C. and a mold temperature of 100° C.
7. The resin composition according to the above paragraph 1 which is a molding material for the key of terminal equipment.
8. A molded article of the resin composition of the above paragraph 1.
9. The molded article according to the above paragraph 8 which has a volume of 5 to 300 mm³ and a thickness of 0.2 to 0.8 mm.
10. The molded article according to the above paragraph 8 which is a key for terminal equipment.
11. A method of manufacturing a molded article by melting the resin composition of the above paragraph 1 at 350 to 420° C. and injection molding it.
12. The manufacturing method according to the above paragraph 11, wherein the resin composition is injection molded with a hot runner mold.
13. The manufacturing method according to the above paragraph 11, wherein the molded article is a key for terminal equipment.

### BRIEF DESCRIPTION OF THE DRAWINGS

FIG. 1 is a schematic diagram of a commonly used metal mold;

FIG. 2 is a schematic diagram of a release force evaluation metal mold used in the present invention;

FIG. 3 is a perspective view of a molded disk used in the measurement of release force;

FIG. 4 is a side view of the molded disk used in the measurement of release force;

FIG. 5 is a schematic diagram of a release force evaluation system and a molding machine used in the present invention;

FIG. 6 is a graph of release force measurement data;

FIG. 7 is an enlarged view of a waveform obtained when a molded article is ejected by an ejector pin in the graph of release force measurement data;

FIG. 8 is a ¹H-NMR spectral chart of an aromatic polycarbonate resin pellet; and

FIG. 9 is a diagram of an apparatus used to synthesize the aromatic polycarbonate resins of Synthesis Examples 1 to 3.

### EXPLANATION OF LETTERS OR NUMERALS

1: a fixed mold
2: a movable mold
3: a cavity
4: an insert
5: a thickness control spacer
6: a gate
7: an ejector pin
8: a quartz piezoelectric force link
9: wire for censor
10: a monitoring system
11: a molding machine
12: a hopper
13: a wire for signal
14: a phosgenation reactor equipped with an anchor type blade
15: a chemical injection port
16: a phosgene supply port
17: a homomixer
18: a polymerization reactor equipped with an anchor type blade

### BEST MODE FOR CARRYING OUT THE INVENTION

The present invention will be described in detail hereinunder.

### <Aromatic Polycarbonate Resin>

The aromatic polycarbonate resin (may be simply referred to as “polycarbonate” hereinafter) is obtained by reacting a diphenol with a carbonate precursor. Examples of the reaction include interfacial polycondensation, melt ester interchange, the solid-phase ester interchange of a carbonate prepolymer and the ring-opening polymerization of a cyclic carbonate compound.

Examples of the diphenol include hydroquinone, resorcinol, 4,4′-biphenol, 1,1-bis(4-hydroxyphenyl)ethane, 2,2-bis(4-hydroxyphenyl)propane (commonly known as “bisphenol A”), 2,2-bis(4-hydroxy-3-methylphenyl)propane, 2,2-bis(4-hydroxyphenyl)butane, 1,1-bis(4-hydroxyphenyl)-1-phenylethane, 1,1-bis(4-hydroxyphenyl)cyclohexane, 1,1-bis(4-hydroxyphenyl)-3,3,5-trimethylcyclohexane, 2,2-bis(4-hydroxyphenyl)pentane, 4,4′-(p-phenylenediisopropylidene)diphenol, 4,4′-(m-phenylenediisopropylidene)diphenol, 1,1-bis(4-hydroxyphenyl)-4-isopropylcyclohexane, bis(4-hydroxyphenyl)oxide, bis(4-hydroxyphenyl)sulfide, bis(4-hydroxyphenyl)sulfoxide, bis(4-hydroxyphenyl)sulfone, bis(4-hydroxyphenyl)ketone, bis(4-hydroxyphenyl)ester, 2,2-bis(3,5-dibromo-4-hydroxyphenyl)propane, bis(3,5-dibromo-4-hydroxyphenyl)sulfone, bis(4-hydroxy-3-methylphenyl)sulfide, 9,9-bis(4-hydroxyphenyl)fluorene and 9,9-bis(4-hydroxy-3-methylphenyl)fluorene. Out of these, bis(4-hydroxyphenyl)alkanes are preferred, and bisphenol A (may be abbreviated as “BPA” hereinafter) is particularly preferred. The content of BPA in the diphenol component is preferably 50 to 100 mol %.

In the present invention, special polycarbonates manufactured by using other diphenols may be used as the component A, besides polycarbonates obtained from bisphenol A.

For example, polycarbonates (homopolymers or copolymers) obtained by using 4,4′-(m-phenylenediisopropylidene)diphenol (may be abbreviated as “BPM” hereinafter), 1,1-bis(4-hydroxyphenyl)cyclohexane, 1,1-bis(4-hydroxyphenyl)-3,3,5-trimethylcyclohexane (may be abbreviated as “Bis-TMC” hereinafter), 9,9-bis(4-hydroxyphenyl)fluorene and 9,9-bis(4-hydroxy-3-methylphenyl)fluorene (may be abbreviated as “BCF” hereinafter) as part or all of the diphenol component are suitable for use in fields in which the requirements for stability to dimensional change by water absorption and form stability are very strict.

The carbonate precursor is a carbonyl halide, carbonate ester or haloformate, as exemplified by phosgene, diphenyl carbonate and dihaloformates of a diphenol.

For the manufacture of the polycarbonate from a diphenol and a carbonate precursor by interfacial polymerization, a catalyst, a terminal capping agent and an antioxidant for preventing the oxidation of the diphenol may be optionally used. The polycarbonate may be a branched polycarbonate obtained by copolymerizing a polyfunctional aromatic compound having 3 or more functional groups. Examples of the polyfunctional aromatic compound having 3 or more aromatic groups used herein include 1,1,1-tris(4-hydroxyphenyl)ethane and 1,1,1-tris(3,5-dimethyl-4-hydroxyphenyl)ethane.

Further, it may be a polyester carbonate obtained by copolymerizing an aromatic or aliphatic (including alicyclic) bifunctional carboxylic acid, a copolycarbonate obtained by copolymerizing a bifunctional alcohol (including an alicyclic bifunctional alcohol) or a polyester carbonate obtained by copolymerizing the bifunctional carboxylic acid and the bifunctional alcohol. It may also be a mixture of two or more of the obtained polycarbonates.

In the polymerization reaction of the polycarbonate, the reaction by the interfacial polycondensation process is generally a reaction between a diphenol and phosgene in the presence of an acid binder and an organic solvent. Examples of the acid binder include alkali metal hydroxides such as sodium hydroxide and potassium hydroxide and amine compounds such as pyridine. Examples of the organic solvent include halogenated hydrocarbons such as methylene chloride and chlorobenzene. A catalyst such as tertiary amine, quaternary ammonium compound or quaternary phosphonium compound exemplified by triethylamine, tetra-n-butylammonium bromide and tetra-n-butylphosphonium bromide may be used to promote the reaction. The reaction temperature is generally 0 to 40° C., the reaction time is about 10 minutes to 5 hours, and pH during the reaction is preferably kept at 9 or more.

In the polycondensation reaction, a terminal capping agent is generally used. A monofunctional phenol may be used as the terminal capping agent. Examples of the monofunctional phenol include phenol, p-tert-butylphenol and p-cumylphenol.

The organic solvent solution of the polycarbonate obtained by the above interfacial polycondensation process is generally washed in water. This washing step is carried out by using water having an electric conductivity of 10 μS/cm or less, more preferably 1 μS/cm or less such as ion exchange water. The above organic solvent solution and water are mixed together, stirred and divided into an organic solvent solution phase and a water phase by still standing or using a centrifugal separator to extract the organic solvent solution phase repeatedly so as to remove water-soluble impurities. The water-soluble impurities are removed efficiently by washing in high-purity water, whereby the hue of the obtained polycarbonate becomes good.

It is also preferred that the organic solvent solution of the polycarbonate should be washed with an acid or alkali to remove impurities such as the catalyst. It is preferred to remove foreign matter which is an insoluble impurity from the organic solvent solution. To remove this foreign matter, the organic solvent solution is preferably filtered or processed by a centrifugal separator.

The solvent is then removed from the organic solvent solution which has been washed in water to obtain a polycarbonate resin particle. To obtain the polycarbonate particle (granulation step), a method of producing slurry by continuously supplying the organic solvent solution of the polycarbonate into a granulator in which a polycarbonate particle and hot water (about 65 to 90° C.) are existent under agitation to evaporate the solvent is preferably employed as it is simple in operation and post-treatment. A mixer such as an agitation tank or kneader is used as the granulator. The produced slurry is continuously discharged from the upper or lower portion of the granulator.

The discharged slurry may be subjected to a hydrothermal treatment. In the hydrothermal treatment step, the organic solvent contained in the slurry is removed by supplying the slurry into a hydrothermal treatment container filled with 90 to 100° C. hot water or setting the temperature of water to 90 to 100° C. by blowing steam after the slurry is supplied.

Water and the organic solvent are then removed from the slurry discharged from the granulating step or from the slurry after the hydrothermal treatment preferably by filtration or centrifugation and then dried to obtain a polycarbonate resin particle (powder or flake).

The drier may be of conduction heating system or hot air heating system, and the polycarbonate resin particle may be left to stand, transferred or stirred. A groove type or cylindrical drier which employs conduction heating system to stir the polycarbonate resin particle is preferred, and a groove type drier is particularly preferred. The drying temperature is preferably in the range of 130 to 150° C.

The melt ester interchange reaction is generally an ester interchange reaction between a diphenol and a carbonate ester. This reaction is carried out by mixing together the diphenol and the carbonate ester under heating in the presence of an inert gas and distilling off the formed alcohol or phenol. The reaction temperature which differs according to the boiling point of the formed alcohol or phenol is 120 to 350° C. in most cases. The inside pressure of the reaction system is reduced to 1.33×10³ to 13.3 Pa in the latter stage of the reaction to facilitate the distillation-off of the formed alcohol or phenol. The reaction time is generally about 1 to 4 hours.

Examples of the carbonate ester include esters such as aryl groups and aralkyl groups having 6 to 10 carbon atoms, and alkyl groups having 1 to 4 carbon atoms all of which may have a substituent. Out of these, diphenyl carbonate is particularly preferred.

The molten polycarbonate resin obtained by the melt ester interchange process can be pelletized by a melt extruder. This pellet is to be molded.

The viscosity average molecular weight of the polycarbonate is preferably 1.0×10⁴ to 5.0×10⁴, more preferably 1.2×10⁴ to 3.0×10⁴, much more preferably 1.5×10⁴ to 2.8×10⁴ because when the viscosity average molecular weight is lower than 1.0×10⁴, strength lowers and when the viscosity average molecular weight is higher than 5.0×10⁴, moldability degrades. In this case, it is possible to mix a polycarbonate having a viscosity average molecular weight outside the above range as long as moldability is maintained. For example, it is possible to mix a polycarbonate component having a viscosity average molecular weight higher than 5.0×10⁴.

The viscosity average molecular weight (M) in the present invention is calculated based on the following equation from the specific viscosity (ηₛₚ) of a solution containing 0.7 g of the polycarbonate dissolved in 100 ml of methylene chloride at 20° C. which is obtained with an Ostwald viscometer based on the following equation.

Specific viscosity (ηₛₚ)=(t−t₀)/t₀

[t₀ is a time (seconds) required for the dropping of methylene chloride and t is a time (seconds) required for the dropping of a sample solution]
ηₛₚ/c=[η]+0.45×[η]²c ([η] represents an intrinsic viscosity)

### [η]=1.23×10⁻⁴M^{0.83}

c=0.7

The viscosity average molecular weight of the polycarbonate can be measured as follows. That is, the polycarbonate resin is dissolved in methylene chloride in a weight ratio of 1:20 to 1:30, soluble matter is collected by cerite filtration, the solution is removed, and the soluble matter is dried completely so as to obtain a methylene chloride-soluble solid. 0.7 g of the solid is dissolved in 100 ml of methylene chloride to measure the specific viscosity (ηₛₚ) of the obtained solution at 20° C. with an Ostwald viscometer so as to calculate its viscosity average molecular weight M from the above equation.

In the present invention, the chlorine atom content of the resin composition can be adjusted by the following method. In the case of the above interfacial polycondensation process, the chlorine atom content can be reduced effectively by intensifying drying in the granulating step. The substitution of the solvent with a solvent containing no Cl such as heptane in the granulating step is also effective. Further, the strengthening of a vacuum vent in the step of melting and pelletizing the resin composition is also effective. Moreover, the chlorine atom content can be reduced by injecting a poor solvent for the polycarbonate resin such as water or heptane at the time of melt extrusion to carry out its azeotropy with the vacuum vent. Meanwhile, the aromatic polycarbonate resin polymerized by the melt ester interchange process is useful as it hardly contains Cl.

In the present invention, the OH terminal group content of the aromatic polycarbonate resin can be adjusted by the following method. In the case of the interfacial polycondensation process, the OH terminal group content can be adjusted by use of a catalyst, the amount of a terminal capping agent and the addition time. To carry out a polymerization reaction in a standing state is also effective in the reduction of the OH terminal group content. In the case of the melt ester interchange process, the OH terminal group content can be reduced by adjusting the ratio of the diphenol to the carbonate ester to such an extent that the amount of the carbonate ester becomes larger than the equimolar amount.

The OH terminal group content of the aromatic polycarbonate resin is 0.1 to 30 eq/ton, preferably 0.1 to 25 eq/ton, more preferably 0.1 to 20 eq/ton. The OH terminal group content of the aromatic polycarbonate resin is measured by NMR.

### <Glycerin Monoester>

In the present invention, a glycerin monoester used as a release agent contains a monoester of glycerin and a fatty acid as the main component. Preferred examples of the fatty acid include saturated fatty acids such as stearic acid, palmitic acid, behenic acid, arachic acid, montanic acid and lauric acid and unsaturated fatty acids such as oleic acid, linoleic acid and sorbic acid. Out of these, stearic acid, behenic acid and palmitic acid are particularly preferred. Glycerin monoesters synthesized from natural fatty acids are preferred, and most of them are mixtures.

The content of the glycerin monoester is 0.01 to 0.3 part by weight, preferably 0.03 to 0.2 part by weight, more preferably 0.05 to 0.15 part by weight based on 100 parts by weight of the aromatic polycarbonate resin (component A). When the content is too low, high releasability is not obtained and when the content is too high, the discoloration of the obtained molded article becomes worse.

The release agent may be used in combination with another release agent which is known among people having ordinary skill in the art. When it is used in combination with another release agent, the content of the glycerin monoester is 0.01 to 0.3 part by weight based on 100 parts by weight of the aromatic polycarbonate resin, and the glycerin monoester is preferably the main component of the release agent.

### <Anthraquinone-Based Dye>

The resin composition of the present invention may contain an anthraquinone-based dye having no OH functional group in the skeleton. Although the anthraquinone-based dye having no OH functional group in the skeleton which is used as a dye includes what are used as a bluing agent by people having ordinary skill in the art, it is not limited to the blue color and many colors such as red, orange, green, yellow or violet may be used. Multiple colors can be obtained by one dye or a combination of dyes.

Examples of the anthraquinone-based dye include the PLAST Blue 8520 (compound of the following formula (1)), PLAST Violet 8855 (compound of the following formula (2)), PLAST Red 8350, PLAST Red 8340, PLAST Red 8320 and OIL Green 5602 of Arimoto Kagaku Kogyo Co., Ltd., the MACROLEX Blue RR (compound of the following formula (3)) of Bayer AG, the DIARESIN Blue N of Mitsubishi Chemical Corporation, the SUMIPLAST Violet RR of Sumitomo Chemical Co., Ltd. and MACROLEX Violet B (compound of the following formula (4)) of Bayer AG. Out of these, the compounds of the formulas (1), (2) and (3) which are anthraquinone-based dyes having no OH functional group in the skeleton are particularly preferred.

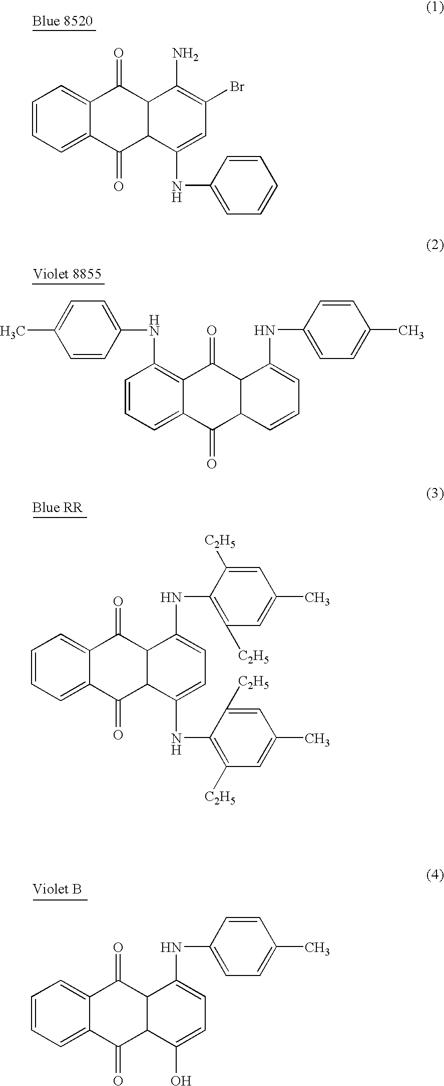

The content of the anthraquinone-based dye (component C) is 1×10⁻⁶ to 1,000×10⁻⁶ part by weight, preferably 5×10⁻⁶ to 500×10⁻⁶ part by weight, more preferably 10×10⁻⁶ to 150×10⁻⁶ part by weight, much more preferably 10×10⁻⁶ to 100×10⁻⁶ part by weight based on 100 parts by weight of the aromatic polycarbonate resin.

Although a dye except the anthraquinone-based dye may be used, it is desired that the anthraquinone-based dye having no OH functional group in the skeleton should account for 50% or more of the total of the dyes. When it is used in combination with another dye, the total amount of the dyes is 1×10⁻⁶ to 1,000×10⁻⁶ part by weight based on 100 parts by weight of the aromatic polycarbonate resin.

The resin composition of the present invention may be mixed with a heat stabilizer, ultraviolet absorbent, antistatic agent, flame retardant, heat ray screening agent, fluorescent brightener, pigment, light diffuser, reinforcement filler, another resin and elastomer in limits not prejudicial to the object of the present invention.

### <Heat Stabilizer>

The heat stabilizer is selected from a phosphorus-based heat stabilizer (component D), sulfur-based heat stabilizer and hindered phenol-based heat stabilizer.

The phosphorus-based heat stabilizer (component D) is a phosphorous acid, phosphoric acid, phosphonous acid, phosphonic acid or ester thereof, as exemplified by triphenyl phosphite, tris(nonylphenyl)phosphite, tris(2,4-di-tert-butylphenyl)phosphite, tris(2,6-di-tert-butylphenyl)phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerithritol diphosphite, bis(2,4-di-tert-butylphenyl)pentaerythritol diphosphite, distearyl pentaerythritol diphosphite, tributyl phosphate, triethyl phosphate, trimethyl phosphate, triphenyl phosphate, diphenylmonoorthoxenyl phosphate, dibutyl phosphate, dioctyl phosphate, diisopropyl phosphate, dimethyl benzenephosphonate, diethyl benzenephosphonate, dipropyl benzenephosphonate, tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, bis(2,4-di-tert-butylphenyl)-4-phenyl-phenyl phosphonite and bis(2,4-di-tert-butylphenyl)-3-phenyl-phenyl phosphonite.

Out of these, tris(2,4-di-tert-butylphenyl)phosphite, tris(2,6-di-tert-butylphenyl)phosphite, tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, bis(2,4-di-tert-butylphenyl)-4-phenyl-phenyl phosphonite and bis(2,4-di-tert-butylphenyl)-3-phenyl-phenyl phosphonite are preferred, and tetrakis(2,4-di-tert-butylphenyl)-4,4′-biphenylene diphosphonite is particularly preferred. The content of the phosphorus-based heat stabilizer (component D) is preferably 0.001 to 0.2 part by weight, more preferably 0.005 to 0.1 part by weight based on 100 parts by weight of the aromatic polycarbonate resin (component A).

Examples of the sulfur-based heat stabilizer include pentaerythritol-tetrakis(3-laurylthiopropionate), pentaerythritol-tetrakis(3-myristylthiopropionate), pentaerythritol-tetrakis(3-stearylthiopropionate), dilauryl-3,3′-thiodipropionate, dimyristyl-3,3′-thiodipropionate and distearyl-3,3′-thiodipropionate, out of which pentaerythritol-tetrakis(3-laurylthiopropionate), pentaerythritol-tetrakis(3-myristylthiopropionate), dilauryl-3,3′-thiodipropionate and dimyristyl-3,3′-thiodipropionate are preferred. Pentaerythritol-tetrakis(3-laurylthiopropionate) is particularly preferred. This thioether-based compound is commercially available from Sumitomo Chemical Co., Ltd. under the trade names of Sumirizer TP-D and Sumirizer TPM and can be easily used. The content of the sulfur-based heat stabilizer is preferably 0.001 to 0.2 part by weight based on 100 parts by weight of the polycarbonate resin (component A).

Examples of the hindered phenol-based heat stabilizer include triethylene glycol-bis[3-(3-tert-butyl-5-methyl-4-hydroxyphenyl) propionate], 1,6-hexanediol-bis[3-(3,5-di-tert-butyl-4-hydroxyphenyl) propionate], pentaerythritol-tetrakis[3-(3,5-di-tert-butyl-4-hydroxyphenyl)propionate], octadecyl-3-(3,5-di-tert-butyl-4-hydroxyphenyl) propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamide), 3,5-di-tert-butyl-4-hydroxy-benzylphosphonate-diethyl ester, tris(3,5-di-tert-butyl-4-hydroxybenzyl)isocyanurate and 3,9-bis{1,1-dimethyl-2-[β-(3-tert-butyl-4-hydroxy-5-methylphenyl)propionyloxy]ethyl}-2,4,8,10-tetraoxaspiro (5,5)undecane, out of which octadecyl-3-(3,5-di-tert-butyl-4-hydroxyphenyl) propionate is particularly preferred. The content of the hindered phenol-based heat stabilizer is preferably 0.001 to 0.1 part by weight based on 100 parts by weight of the polycarbonate resin (component A).

### <Ultraviolet Absorbent>

The ultraviolet absorbent is preferably at least one selected from the group consisting of a benzotriazole-based ultraviolet absorbent, benzophenone-based ultraviolet absorbent, triazine-based ultraviolet absorbent, cyclic iminoester-based ultraviolet absorbent and cyanoacrylate-based ultraviolet absorbent.

Examples of the benzotriazole-based ultraviolet absorbent include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2N-benzotriazol-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylenebis(4-cumyl-6-benzotriazolephenyl), 2,2′-p-phenylenebis(1,3-benzoxazin-4-one) and 2-[2-hydroxy-3-(3,4,5,6-tetrahydrophthalimidomethyl)-5-methylphenyl]benzotriazole. They may be used alone or in combination of two or more.

2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2H-benzotriazol-2-yl)phenol] and 2-[2-hydroxy-3-(3,4,5,6-tetrahydrophthalimidomethyl)-5-methylphenyl]benzotriazole are preferred, and 2-(2-hydroxy-5-tert-octylphenyl)benzotriazole and 2,2′-methylenebis[4-(1,1,3,3-tetramethylbutyl)-6-(2H-benzotriazol-2-yl)phenol] are more preferred.

Examples of the benzophenone-based ultraviolet absorbent include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydride benzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxybenzophenone, bis(5-benzoyl-4-hydroxy-2-methoxyphenyl)methane, 2-hydroxy-4-n-dodecyloxybenzophenone and 2-hydroxy-4-methoxy-2′-carboxybenzophenone.

Examples of the triazine-based ultraviolet absorbent include 2-(4,6-diphenyl-1,3,5-triazin-2-yl)-5-[(hexyl)oxy]-phenol, and 2-(4,6-bis(2,4-dimethylphenyl)-1,3,5-triazin-2-yl)-5-[(octyl)oxy]-phenol.

Examples of the cyclic iminoester-based ultraviolet absorbent include 2,2′-bis(3,1-benzoxazin-4-one), 2,2′-p-phenylenebis(3,1-benzoxazin-4-one), 2,2′-m-phenylenebis(3,1-benzoxazin-4-one), 2,2′-(4,4′-diphenylene)bis(3,1-benzoxazin-4-one), 2,2′-(2,6-naphthalene)bis(3,1-benzoxazin-4-one), 2,2′-(1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one) and 2,2′-(2-chloro-p-phenylene)bis(3,1-benzoxazin-4-one). Out of these, 2,2′-p-phenylenebis(3,1-benzoxazin-4-one), 2,2′-(4,4′-diphenylene)bis(3,1-benzoxazin-4-one) and 2,2′-(2,6-naphthalene)bis(3,1-benzoxazin-4-one) are preferred, and 2,2′-p-phenylenebis(3,1-benzoxazin-4-one) is particularly preferred. This compound is commercially available from Takemoto Yushi Co., Ltd. under the trade name of CEi-P and can be easily used.

Examples of the cyanoacrylate-based ultraviolet absorbent include 1,3-bis[(2′-cyano-3′,3′-diphenylacryloyl)oxy]-2,2-bis[(2-cyano-3,3-diphenylacryloyl)oxy]methyl)propane and 1,3-bis-[(2-cyano-3,3-diphenylacryloyl)oxy]benzene.

The content of the ultraviolet absorbent is preferably 0.01 to 3.0 parts by weight, more preferably 0.02 to 1.0 part by weight, much more preferably 0.05 to 0.8 part by weight based on 100 parts by weight of the aromatic polycarbonate resin (component A). Within the above range, sufficiently high weatherability can be provided to a molded article according to application purpose.

The resin composition of the present invention may be mixed with another resin as long as its hue is satisfactory. Examples of the another thermoplastic resin except the polycarbonate resin include general-purpose plastics typified by polycaprolactone resin, polyethylene resin, polypropylene resin, polystyrene resin, polyacryl styrene resin, ABS resin, AS resin, AES resin, ASA resin, SMA resin and polyalkyl methacrylate resin, engineering plastics typified by polyphenylene ether resin, polyacetal resin, aromatic polyester resin, polyamide resin, cyclic polyolefin resin and polarylate resin (amorphous polyarylate and liquid crystalline polyarylate), and so-called super engineering plastics such as polyether ether ketone, polyether imide, polysulfone, polyether sulfone and polyphenylene sulfide. Further, thermoplastic elastomers such as styrene-based thermoplastic elastomers, olefin-based thermoplastic elastomers, polyamide-based thermoplastic elastomers, polyester-based thermoplastic elastomers and polyurethane-based thermoplastic elastomers may also be used.

The resin composition of the present invention may be mixed with a flame retardant as long as its hue is satisfactory. The flame retardant which can be used is not particularly limited. Examples of the flame retardant include polycarbonate-based flame retardants of halogenated bisphenol A, organic salt-based flame retardants, aromatic phosphate-based flame retardants, halogenated aromatic phosphate-based flame retardants and silicone-based flame retardants. The resin composition of the present invention may be mixed with at least one of them.

### <Physical Properties of Resin Composition>

The chlorine atom content of the resin composition is 100 ppm or less, preferably 0.1 to 100 ppm, more preferably 0.1 to 70 ppm, much more preferably 0.1 to 50 ppm. The chlorine atom content of the resin composition is measured by a combustion method. A sample is weighed, burnt in a mixed gas stream of argon and oxygen and titrated by the amount of charge transfer of a silver electrode. The measurement can be carried out with the TOX-2100H of Mitsubishi Chemical Corporation.

The hue values of a 2 mm-thick molded article formed from the resin composition of the present invention at 370° C. fall within the following ranges as JISK7105 transmission measurement values.

L value=85.0 to 90.0
a value=−1.3 to −1.9
b value=1.5 to 4.5

Especially the b value has a great influence upon the hue required in the present invention. The b value is more preferably 1.8 to 4.2, particularly preferably 2.0 to 4.0.

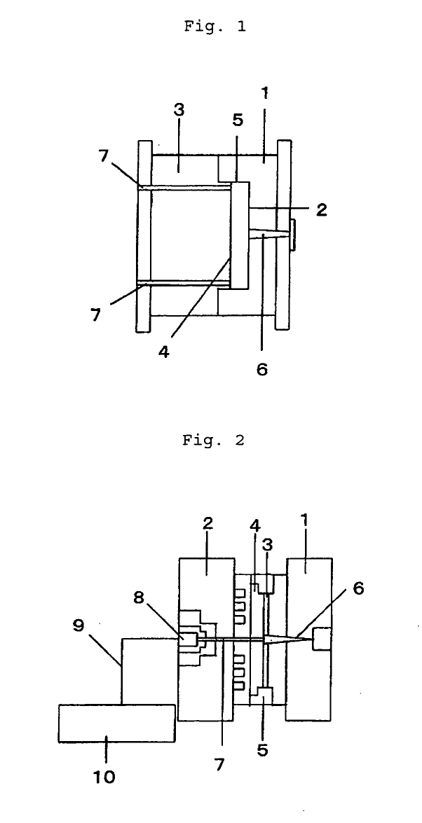

A description is subsequently given of the method of measuring the vacuum adhesion to a metal mold of the resin composition of the present invention. The metal mold used in the vacuum adhesion measuring method is shown in FIG. 2 (a commonly used metal mold is shown in FIG. 1 as a reference). As shown in FIG. 2, a convex fixed mold 1 is installed on the right side and a concave movable mold 2 is installed on the left side. A cavity 3 is formed between these molds. The cavity is shaped like a disk having a diameter of 115 mm.

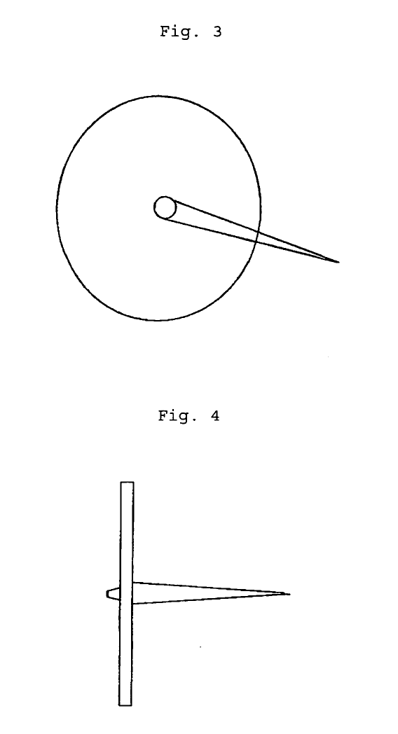

The molded article is shown in FIG. 3 and FIG. 4. FIG. 3 is a perspective view of the molded article and FIG. 4 is a side view thereof. A gate 6 is open on the right side at the center of the cavity 3. An insert 4 polished to a predetermined arithmetic average roughness Ra is installed at the center of the movable mold 2 and a product thickness control spacer 5 is installed around the insert 4. In the method of the present invention, the vacuum adhesion is measured at a mold smoothness (Ra) of 0.01 μm and a product thickness (t) of 3 mm. Further, an ejector pin 7 is inserted into the center of the insert 4 at the center of the movable mold 2, and a quartz piezoelectric force link 8 (manufactured by Nippon Kisler Co., Ltd.) is installed behind the pin and further connected to a monitoring system 10 (manufactured by Nippon Kisler Co., Ltd.) by a wire 9.

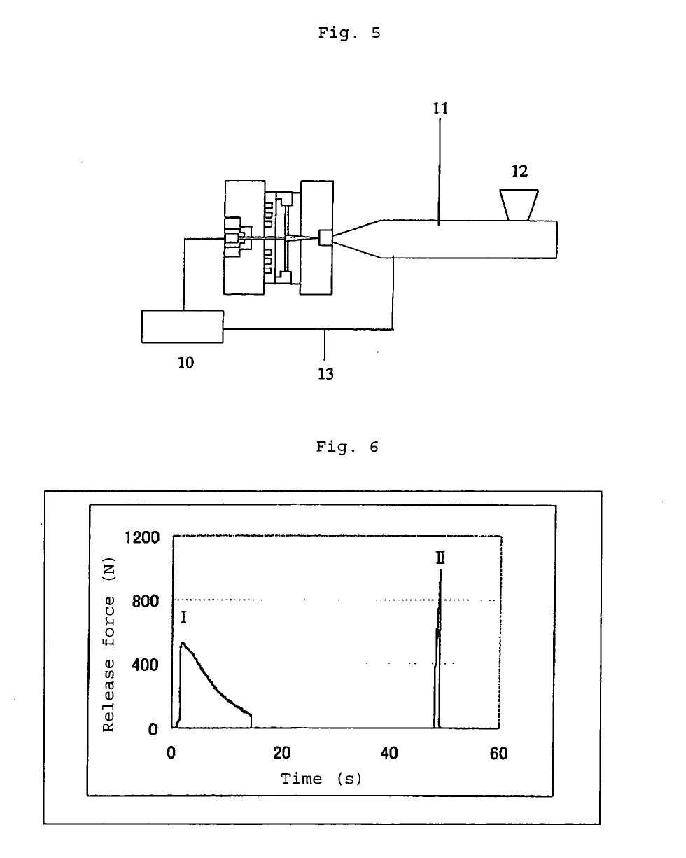

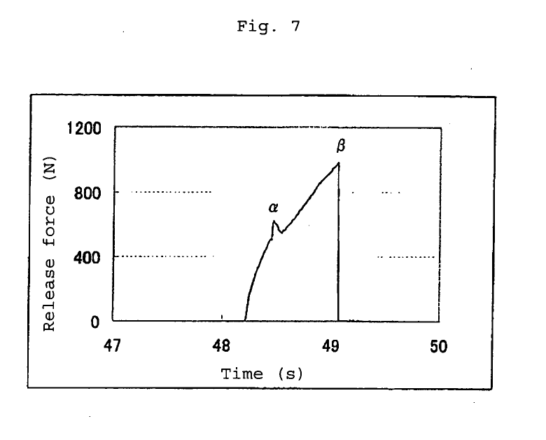

As shown in FIG. 5, the monitoring system 10 and a molding machine 11 are connected by a wire 13 so that a pressure applied to the ejector pin can be measured for a predetermined time right after an injection signal of the molding machine 11 is applied to the monitoring system 10.

After clamping was adjusted by using a molding machine having a clamping force of 260 t, a pellet was charged from a hopper 12, the resin composition which had been plasticized and molten at 350° C. was injection charged into the cavity 3 between the fixed mold 1 and the movable mold 2 set to a mold temperature of 100° C. at an injection pressure of 65 MPa, maintained at a holding pressure of 90 MPa for 7 seconds and cooled for 35 seconds to be solidified, and a molded article was removed by ejecting it with the ejector pin to measure its vacuum adhesion to the mold when it was removed from the mold. The measurement data were supplied to the monitoring system 10 to be processed. 30 shots were continuously molded and the average value of 20 to 30 shots was evaluated as vacuum adhesion in the present invention.

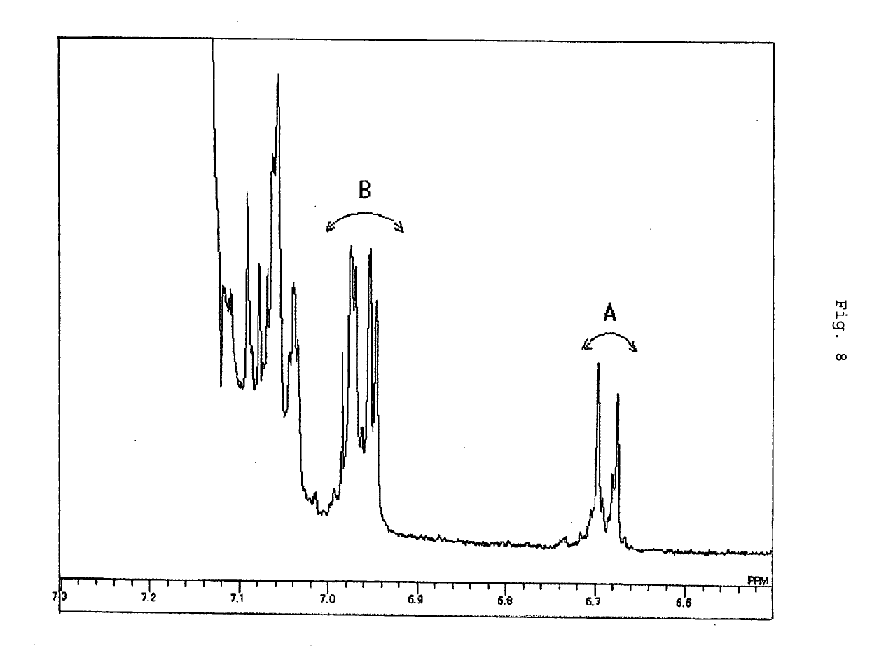

The whole waveform at the time of releasing the molded article is shown in FIG. 6. The initial peak I is a peak derived from injection pressure, and a peak II is a peak at the time of ejecting with the ejector. The enlarged peak II is shown in FIG. 7. When the peak at the time of ejecting with the ejector is enlarged as shown in FIG. 7, it is understood that there are two peaks α and β. It is considered that the peak α is derived from vacuum adhesion at the interface between the molded article and the metal mold and the peak β is derived from the resistance of the edge portion of the molded article. In the present invention, the maximum value of the release peak α is defined and evaluated as vacuum adhesion for releasing the molded article from its vacuum adhesion state to the metal mold.

The vacuum adhesion of the resin composition of the present invention is preferably 300 to 800 N, more preferably 300 to 600 N. When the vacuum adhesion is high, it causes product defects such as deformation at the time of molding a portable key top and cracking at the time of coating due to large residual stress. When the vacuum adhesion is 300 N, a release problem does not occur. The resin composition of the present invention is suitable as a molding material for the key of terminal equipment.

### <Molding>

The present invention includes a molded article of the above resin composition. The molded article of the present invention has a volume of preferably 5 to 300 mm³, more preferably 10 to 200 mm³. The molded article of the present invention has a thickness of preferably about 0.2 to 0.8 mm, more preferably about 0.2 to 0.5 mm. Therefore, the molded article of the present invention is preferably a small-sized molded article having a volume of 5 to 300 mm³ and a thickness of about 0.2 to 0.8 mm. It is particularly preferably a key for terminal equipment such as mobile phones.

The molding temperature of the resin composition of the present invention is preferably 350 to 420° C. It is more preferably 360° C. or higher, much more preferably 370° C. or higher. It is preferably 400° C. or lower, more preferably 390° C. or lower, particularly preferably 380° C. or lower.

Examples of the molding technique include injection molding, injection compression molding, injection press molding, extrusion compression molding, extrusion molding, rotational molding, blow molding, compression molding, inflation molding, calender molding, vacuum molding and foam molding. Injection molding, injection compression molding, injection press molding and extrusion compression molding are most commonly used. Further, after the molding of the resin composition of the present invention, two-color molding in which the molded article is transferred to a similar or different metal mold and another thermoplastic resin is molded, or in-mold coating in which a thermosetting resin is molded on the molded article of the present invention may be carried out.

Particularly when the molding technique is injection molding or injection compression molding, injection pressure is required to mold a thin molded article, whereby the molding machine becomes large in size. Thereby, the cylinder capacity of the molding machine becomes large and the residence time of the resin in the cylinder tends to be long. Since the residence time has a greater influence upon the hue as the residence time increases, care must be taken. The maximum capacity of the cylinder is preferably 1.5 to 15 times, more preferably 1.5 to 5 times, most preferably 1.5 to 3 times the volume of the molded article.

Therefore, the present invention includes a method of manufacturing a molded article by melting the above resin composition at 350 to 420° C. and injection molding it. Injection molding is preferably carried out with a hot runner metal mold.

The molded article is preferably a key for terminal equipment. The key for terminal equipment is a switch which is used to input data into portable terminal equipment. In general, a light screening layer is formed on the rear surface, part of the light screening layer is removed to form a character or symbol, and the key top is illuminated from the back to show the character or symbol.

Since the key of terminal equipment is small and a projecting portion is rarely formed on the molded article, an ejector is formed on a sprue portion or useless portion of molded article for guiding it to the molded article. Therefore, as the weight ratio of the molded article to the molding shot decreases and the ratio of a scrapped portion increases, a hot runner mold is now under study. In the case of a hot runner mold, higher heat stability and discoloration resistance at a high temperature are required and therefore, the resin composition of the present invention is advantageously used.

### EXAMPLES

The following examples are provided for the purpose of further illustrating the present invention but are in no way to be taken as limiting. The physical properties in the examples were measured by the following methods.

### (1) Chlorine Atom Contents of Aromatic Polycarbonate Resin (Powder) and Resin Composition (Pellet)

The aromatic polycarbonate resin powder and pellet were weighed, burnt in a mixed gas stream of argon and oxygen and titrated by the amount of charge transfer of a silver electrode. The measurement was carried out by using the TOX-2100H of Mitsubishi Chemical Corporation.

### (2) OH Terminal Group Content of Aromatic Polycarbonate Resin

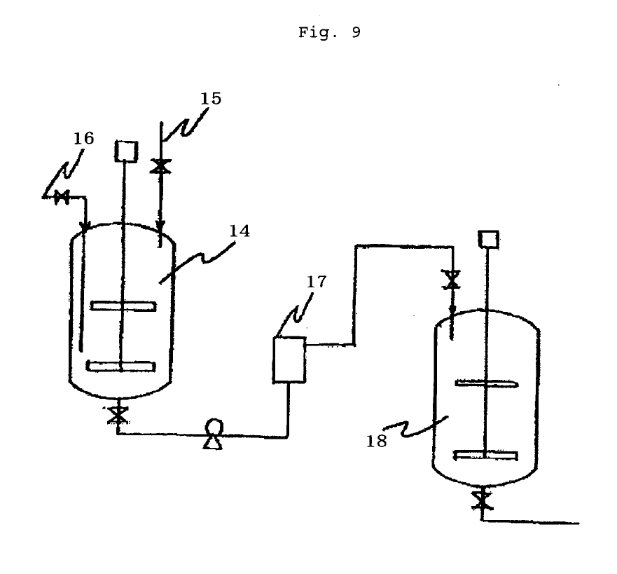

40 mg of the aromatic polycarbonate resin powder and 40 mg of the aromatic polycarbonate resin pellet were each dissolved in 1 ml of heavy chloroform, the resulting solutions were each fed to an NMR sample tube having an inner diameter of 5 mm up to a height of 40 mm, and the sample tubes were capped to prepare NMR measurement samples. The ¹H-NMR measurement of these samples was carried out by using the FT-NMR AL-400 of JEOL Ltd. in anon-decoupling manner 512 times in total. The integral value of peaks at chemical shifts of 6.66 to 6.73 ppm and 6.93 to 7.00 ppm was obtained from the obtained NMR spectral chart to calculate the OH terminal group content (eq/ton) from the following equation. The chart used for the measurement and the peaks are shown in FIG. 8.

OH terminal group content (eq/ton)=(A/2)/(B/(C× 2/100))×1000000/D)

A: integral value of peaks at 6.66 to 6.73 ppm
B: integral value of peaks at 6.93 to 7.00 pm
C: existence of carbon isotope ¹³C (1.108%)
D: mass number per 1 unit of PC (bisphenol A polycarbonate: 254)

### (3) Evaluation of Hue Values (L, a, b)

The pellet was molded into a 2 mm-thick square plate at a cylinder temperature of 370° C., a mold temperature of 80° C. and a molding cycle of 1 minute by using the J85-ELIII injection molding machine of the Japan Steel Works, Ltd. Molding was carried out at a molding cycle of 120 seconds, 100 shots were continuously molded, the hue was stabilized, and then the average hue values of 95th to 100-th shots were calculated. The hue values (L, a, b) were measured by a C light source reflection method using the SE-2000 color difference meter of Nippon Denshoku Co., Ltd.

### (4) Evaluation Of Hue (Color Difference ΔE)

The pellet was molded into a 2 mm-thick square plate at a cylinder temperature of 370° C., a mold temperature of 80° C. and a molding cycle of 1 minute by using the J85-ELIII injection molding machine of the Japan Steel Works, Ltd. After 20 shots were molded continuously, the resin was retained in the cylinder of the injection molding machine for 10 minutes and then molded into a 2 mm-thick square plate. The hue values (L, a, b) of the flat plate before and after its residence were measured by the C light source reflection method using the SE-2000 color difference meter of Nippon Denshoku Co., Ltd. to obtain a color difference ΔE from the following equation.

ΔE={(L−L′)2+(a−a′)2+(b−b′)2}½

hue values of [measurement flat plate before residence]: L, a, b
hue values of [measurement flat plate after residence]: L′, a′, b′

### (5) Measurement of Vacuum Adhesion

After the pellet was injected into a molding machine having a clamping force of 260 t from the hopper 12, the resin composition which had been plasticized and molten at 350° C. was injection charged into the cavity 3 between the fixed mold 1 and the movable mold 2 set to a mold temperature of 100° C. at an injection pressure of 65 MPa, maintained at a holding pressure of 90 MPa for 7 seconds and cooled for 35 seconds to be solidified, and a molded article (disk-like molded article having a diameter of 115 mm and a thickness of 3 mm shown in FIG. 3 and FIG. 4) was removed by ejecting it with the ejector pin to measure its vacuum adhesion to the mold at the time of removing from the mold. The measurement data were supplied to the monitoring system 10 to be processed. 30 shots were continuously molded, and the average value of 20 to 30 shots was evaluated as vacuum adhesion in the present invention (see FIG. 2 and FIG. 5).

The whole waveform showing release force at the time of releasing the molded article is shown in FIG. 6. The initial peak I is a peak derived from injection pressure, and the peak II is a peak at the time of ejecting with the ejector. FIG. 7 is an enlarged view of the peak II. When the peak at the time of ejecting with the ejector is enlarged as shown in FIG. 7, there are two peaks α and β. It is considered that the peak α is derived from vacuum adhesion at the interface between the molded article and the metal mold and the peak β is derived from the resistance of the edge portion of the molded article. The maximum value (N) of the release peak α is defined and evaluated as vacuum adhesion for releasing the molded article from its vacuum adhesion state to the metal mold.

### (6) Evaluation of Physical Properties

A key-like molded article for the SH904i mobile terminal of NTT Docomo Co., Ltd. was molded from the pellet. The pellet was molded at a cylinder temperature of 365° C., a mold temperature of 150° C. and a molding cycle of 40 seconds by using the SE-100D molding machine of Sumitomo Chemical Co., Ltd. The residence time was about 15 minutes. The key-like molded article for terminal equipment was evaluated by using a key striking tester. For evaluation, the key was struck with a 3 mm probe 30,000 times at a frequency of 5 Hz under a maximum load of 50 g. It was checked whether the molded article cracked or broke after striking.

### Synthesis Example 1

FIG. 9 is a schematic diagram of the apparatus used. In FIG. 9, reference numeral 14 denotes a phosgenation reactor equipped with an anchor type blade, 15 a chemical (an alkali aqueous solution of an aromatic bisphenol compound, an organic solvent, a molecular weight control agent, etc.) injection port, 16 a phosgene supply port, 17 a homomixer and 18 a polymerization reactor equipped with an anchor type blade.

An aqueous solution prepared by dissolving 2.23 parts by weight of bisphenol A and 0.005 part by weight of hydrosulfite in 10.7 parts by weight of a 10% NaOH aqueous solution was injected into the phosgenation reactor 14 from the chemical injection port 15, 7.54 parts by weight of methylene chloride was further added from the chemical injection port 15, and 1.12 parts by weight of phosgene was blown into the reactor under agitation at 210 rpm at a reaction temperature of 25±1° C. over 90 minutes. Then, 1.05 parts by weight of a NaOH aqueous solution of p-tert-butylphenol (p-tert-butylphenol concentration of 69.1 g/l, NaOH concentration of 12.5 g/l) as a molecular weight control agent was injected from the chemical injection port 15 and stirred at 8,000 rpm with the SL type homomixer 17 for 2 minutes, and the obtained highly emulsified product was supplied into the polymerization reactor 18 and kept at a temperature of 30±1° C. while it was left to stand without agitation to carry out a polymerization reaction for 2 hours in the end. Methylene chloride was added to this solution until the polycarbonate resin content of the methylene chloride layer became 12 wt % and was diluted, the water layer was separated and removed, and the methylene chloride layer was fully washed in water. This polycarbonate resin solution was charged into a kneader, and the solution was removed to obtain a polycarbonate resin powder. After dehydration, the powder was dried with a hot air circulation drier for 10 hours.

### Synthesis Example 2

The procedure of Synthesis Example 1 was repeated except that the drying time was changed to 5 hours.

### Synthesis Example 3

The procedure of Synthesis Example 1 was repeated except that a reaction was carried out while the reaction mixture was stirred at 200 rpm in the polymerization reactor 5.

### Examples 1 and 2

Resin compositions obtained by blending together components shown in Table 1 were each extruded into a strand at 300° C. by using the TEX-30α of the Japan Steel Works, Ltd., and then the strands were cut to obtain pellets. The obtained pellets were dried at 120° C. for 4 hours. The obtained pellets were evaluated for the above items (1), (2) and (4) to (6). The results are shown in Table 1.

### Examples 3 to 5 and Comparative Examples 1 to 3

Resin compositions obtained by blending together components shown in Table 2 were each extruded into a strand at 300° C. by using the TEX-30α of the Japan Steel Works, Ltd., and then the strands were cut to obtain pellets. The obtained pellets were dried at 120° C. for 4 hours. The obtained pellets were evaluated for the above items (1) to (3). The results are shown in Table 1.

### Examples 6 to 8 and Comparative Examples 4 to 7

Polycarbonate resin compositions obtained by blending together components shown in Table 3 were each extruded into a strand at 300° C. by using the TEX-30α of the Japan Steel Works, Ltd., and then the strands were cut to obtain pellets. The obtained pellets were dried at 120° C. for 4 hours. The obtained pellets were evaluated for the above items (1), (2) and (4) to (6). The results are shown in Table 2.

### Examples 9 and Comparative Example 8

The compositions of Example 6 and Comparative Example 6 which had no problem in the key striking test were molded by using a hot runner mold to obtain key-like molded articles for the evaluation of physical properties (6). The hot runner temperature was set to 365° C., and the SE-100D molding machine of Sumitomo Chemical Co., Ltd. was used to mold these compositions at a cylinder temperature of 365° C., a mold temperature of 150° C. and a molding cycle of 40 seconds. The residence time was about 22 minutes. When the appearances of the molded articles were checked, the discoloration of the molded article of Example 6 was visually imperceptible but the discoloration of the molded article of Comparative Example 6 was apparent.

The components in the tables are given below.
PC1: aromatic polycarbonate resin powder having a molecular weight of 19,000 synthesized in Synthesis Example 1 (chlorine atom content of 380 ppm, terminal OH group content of 15 eq/ton)
PC2: aromatic polycarbonate resin powder having a molecular weight of 19,000 synthesized in Synthesis Example 2 (chlorine atom content of 1,220 ppm, terminal OH group content of 15 eq/ton)
PC3: aromatic polycarbonate resin powder having a molecular weight of 19,000 synthesized in Synthesis Example 3 (chlorine atom content of 420 ppm, terminal OH group content of 35 eq/ton)
PC1 to PC3 may be referred to as “PC”.
L1: S-100A internal release agent of Riken Vitamin Co., Ltd. (main component: glycerin monostearate)
L2: VPG860 internal release agent of Cognis Japan Co., Ltd. (main component: pentaerythritol tetrastearate)
A1: P-EPQ phosphorus-based stabilizer of Clariant Japan Co., Ltd.

P-EPQ was treated at 50° C. and 90% RH for 24 hours and ground before use.

Anthraquinone-based dyes having no OH functional group in the skeleton:
H1: PLAST Blue 8520 of Arimoto Kagaku Kogyo Co., Ltd. (compound of the formula (1))
H2: PLAST Violet 8855 of Arimoto Kagaku Kogyo Co., Ltd. (compound of the formula (2))
H3: MACROLEX Blue RR of Bayer AG (compound of the formula (3))
Anthraquinone-based dye having an OH functional group in the skeleton
H4: MACROLEX Violet B of Bayer AG (compound of the formula (4))

TABLE 1

| | | Example 1 | Example 2 |
|---|---|---|---|
| PC1 | parts by | 100 | 100 |
| | weight | | |
| PC2 | parts by | — | — |
| | weight | | |
| PC3 | parts by | — | — |
| | weight | | |
| L1 | parts by | 0.1 | 0.05 |
| | weight | | |
| L2 | parts by | — | — |
| | weight | | |
| A1 | parts by | 0.02 | 0.02 |
| | weight | | |
| H4 | ×10⁻⁶ parts by | 50 | 50 |
| | weight | | |
| Amount of Cl | ppm | 35 | 33 |
| Terminal OH group | Eq/ton | 15 | 15 |
| content of PC | | | |
| Vacuum adhesion | N | 560 | 750 |
| Discoloration | ΔE | 0.8 | 0.6 |
| Key tapping test | visual check | no problem | no problem |

L1, L2, A1 and H4 are based on 100 parts by weight of aromatic polycarbonate (component A).

TABLE 2

| | | Example | Example | Example | Comparative | Comparative | Comparative |
|---|---|---|---|---|---|---|---|
| | | 3 | 4 | 5 | Example 1 | Example 2 | Example 3 |
| PC1 | Parts by | 100 | 100 | 100 | 100 | — | — |
| | weight | | | | | | |
| PC2 | Parts by | — | — | — | — | 100 | — |
| | weight | | | | | | |
| PC3 | Parts by | — | — | — | — | — | 100 |
| | weight | | | | | | |
| L1 | Parts by | 0.1 | 0.1 | 0.1 | 0.5 | 0.1 | 0.1 |
| | weight | | | | | | |
| A1 | Parts by | 0.02 | 0.02 | 0.02 | 0.02 | 0.02 | 0.02 |
| | weight | | | | | | |
| H1 | ×10⁻⁶ parts | 50 | — | — | 50 | 50 | 50 |
| | by weight | | | | | | |
| H2 | ×10⁻⁶ parts | — | 50 | — | — | — | — |
| | by weight | | | | | | |
| H3 | ×10⁻⁶ parts | — | — | 50 | — | — | — |
| | by weight | | | | | | |
| Amount of Cl | ppm | 35 | 35 | 35 | 39 | 115 | 40 |
| Terminal OH | eq/ton | 15 | 15 | 15 | 15 | 15 | 35 |
| group content | | | | | | | |
| of PC | | | | | | | |
| Hue value | L | 86.8 | 86.5 | 87.2 | 83.3 | 85.8 | 84.4 |
| | a | −1.7 | −1.4 | −1.6 | −2.4 | −2.0 | −2.2 |
| | b | 3.8 | 3.9 | 3.6 | 8.2 | 4.7 | 5.9 |

L1, A1 and H1 to H3 are based on 100 parts by weight of aromatic polycarbonate (component A).

TABLE 3

| | | Ex. 6 | Ex. 7 | Ex. 8 | C. Ex. 4 | C. Ex. 5 | C. Ex. 6 | C. Ex. 7 |
|---|---|---|---|---|---|---|---|---|
| PC1 | parts by | 100 | 100 | 100 | 100 | 100 | — | — |
| | weight | | | | | | | |
| PC2 | parts by | — | — | — | — | — | 100 | — |
| | weight | | | | | | | |
| PC3 | parts by | — | — | — | — | — | — | 100 |
| | weight | | | | | | | |
| L1 | parts by | 0.1 | 0.1 | 0.1 | — | 0.5 | 0.1 | 0.1 |
| | weight | | | | | | | |
| L2 | parts by | — | — | — | 0.1 | — | — | — |
| | weight | | | | | | | |
| A1 | parts by | 0.02 | 0.02 | 0.02 | 0.02 | 0.02 | 0.02 | 0.02 |
| | weight | | | | | | | |
| H1 | ×10⁻⁶ parts by | 50 | — | — | 50 | 50 | 50 | 50 |
| | weight | | | | | | | |
| H2 | ×10⁻⁶ parts by | — | 50 | — | — | — | — | — |
| | weight | | | | | | | |
| H3 | ×10⁻⁶ parts by | — | — | 50 | — | — | — | — |
| | weight | | | | | | | |
| Amount of C1 | ppm | 35 | 35 | 35 | 38 | 39 | 115 | 40 |
| Terminal OH | Eq/ton | 15 | 15 | 15 | 15 | 15 | 15 | 35 |
| group content | | | | | | | | |
| of PC | | | | | | | | |
| Vacuum | N | 550 | 530 | 550 | 810 | 470 | 600 | 610 |
| adhesion | | | | | | | | |
| Discoloration | ΔE | 0.3 | 0.2 | 0.4 | 0.3 | 3.4 | 1.3 | 1.6 |
| Key tapping | visual check | No | No | No | | cracked | No | No |
| test | | problem | problem | problem | | | problem | problem |

 could not prepare a sample due to a release failure
L1, L2, A1 and H1 to H3 are based on 100 parts by weight of aromatic polycarbonate (component A).

### EFFECT OF THE INVENTION

The resin composition of the present invention is free from a release failure even when it is molded at a high temperature and a molded product obtained therefrom, especially a key for terminal equipment has a satisfactory hue without discoloration, excellent transparency and strength.

### INDUSTRIAL FEASIBILITY

The resin composition of the present invention is useful as a molding material for the key of terminal equipment.

1. A resin composition comprising 100 parts by weight of an aromatic polycarbonate having an OH terminal group content of 0.1 to 30 eq/ton (component A) and 0.01 to 0.3 part by weight of a glycerin monoester (component B) and having a chlorine atom content of 100 ppm or less.

2. The resin composition according to claim 1 which has a chlorine atom content of 0.1 to 100 ppm.

3. The resin composition according to claim 1 which comprises an anthraquinone-based dye having no OH functional group in the skeleton (component C) in an amount of 1×10⁻⁶ to 0.001 part by weight based on 100 parts by weight of the aromatic polycarbonate (component A).

4. The resin composition according to claim 1 which comprises a phosphorus-based heat stabilizer (component D) in an amount of 0.001 to 0.2 part by weight based on 100 parts by weight of the aromatic polycarbonate (component A).

5. The resin composition according to claim 1 whose molded article having a thickness of 2 mm has color values within the following ranges as JISK7105 transmission measurement values when it is molded at 370° C.:
L value=85.0 to 90.0
a value=−1.3 to −1.9
b value=1.5 to 4.5.

6. The resin composition according to claim 1 whose molded article has a vacuum adhesion to a metal mold of 300 to 800 N when it is molded at a molding temperature of 350° C. and a mold temperature of 100° C.

7. The resin composition according to claim 1 which is a molding material for the key of terminal equipment.

8. A molded article of the resin composition of claim 1.

9. The molded article according to claim 8 which has a volume of 5 to 300 mm³ and a thickness of 0.2 to 0.8 mm.

10. The molded article according to claim 8 which is a key for terminal equipment.

11. A method of manufacturing a molded article by melting the resin composition of claims 1 at 350 to 420° C. and injection molding it.

12. The manufacturing method according to claim 11, wherein the resin composition is injection molded with a hot runner mold.

13. The manufacturing method according to claim 11, wherein the molded article is a key for terminal equipment.
